(19) United States
(12) Patent Application Publication
(10) Pub. No.: US 2018/0290125 A1
(43) Pub. Date: Oct. 11, 2018

(54) REUSABLE ADSORBENTS FOR REMOVAL AND PURIFICATION OF HYDROPHOBIC MATERIALS FROM FLUIDS

(71) Applicant: Texas State University, San Marcos, TX (US)

(72) Inventors: Gary W. Beall, San Marcos, TX (US); Archana Gujjari, San Marcos, TX (US)

(73) Assignee: Texas State University, San Marcos, TX (US)

(21) Appl. No.: 15/945,643

(22) Filed: Apr. 4, 2018

Related U.S. Application Data
(60) Provisional application No. 62/481,805, filed on Apr. 5, 2017.

(51) Int. Cl. B01J 20/16; B01J 20/26; B01D 17/02; C02F 1/28

(52) U.S. Cl. CPC B01J 20/165; B01J 20/26; C02F 2103/10; C02F 1/281; B01D 17/0202

(57) ABSTRACT

Embodiments of the present disclosure pertain to adsorbents for removing hydrophobic materials from a fluid. The adsorbents include a modified clay and a binding material associated with the modified clay. The modified clay may be functionalized with a plurality of oleophilic functional groups, such as silane coupling agents. The binding material may include polymers, asphalt, and cement. Additional embodiments pertain to methods of removing hydrophobic materials from a fluid by associating the fluid with the aforementioned adsorbents. This results in adsorption of hydrophobic materials from the fluid to the adsorbent and formation of hydrophobic material-adsorbent complexes. The methods may also include one or more steps of separating the hydrophobic material-adsorbent complexes from the fluid, releasing the adsorbed hydrophobic materials from the hydrophobic material-adsorbent complexes to result in the regeneration of the adsorbent, reusing the regenerated adsorbent for removing additional hydrophobic materials from fluids, and purifying the released hydrophobic materials.

### CROSS-REFERENCE TO RELATED APPLICATIONS

This application claims priority to U.S. Provisional Patent Application No. 62/481,805, filed on Apr. 5, 2017. The entirety of the aforementioned application is incorporated herein by reference.

### STATEMENT REGARDING FEDERALLY SPONSORED RESEARCH

Not applicable.

### BACKGROUND

The removal of hydrophobic materials from various fluids through the use of adsorbents presents numerous challenges, including limited capacity, limited regeneration of adsorbents, limited adsorbent reusability, and limited recovery of the adsorbed hydrophobic materials. Numerous embodiments of the present disclosure address the aforementioned limitations.

### SUMMARY

In some embodiments, the present disclosure pertains to adsorbents for removing hydrophobic materials from a fluid. In some embodiments, the adsorbents include a modified clay and a binding material associated with the modified clay. In some embodiments, the modified clay is functionalized with a plurality of oleophilic functional groups, such as silane coupling agents. In some embodiments, the binding material includes, without limitation, polymers, asphalt, cement, and combinations thereof. In some embodiments, the binding material is a polymer, such as a thermoplastic polymer or a thermoset polymer.

In additional embodiments, the present disclosure pertains to methods of removing hydrophobic materials from a fluid by associating the fluid with the adsorbents of the present disclosure. The association results in adsorption of at least some of the hydrophobic materials from the fluid to the adsorbent to form hydrophobic material-adsorbent complexes.

In some embodiments, the methods of the present disclosure also include a step of separating the hydrophobic material-adsorbent complexes from the fluid. In some embodiments, the methods of the present disclosure also include a step of releasing the adsorbed hydrophobic materials from the hydrophobic material-adsorbent complexes to result in the regeneration of the adsorbent. In some embodiments, the releasing occurs by exposing the hydrophobic material-adsorbent complexes to a regenerative medium to result in a transfer of the hydrophobic materials from the hydrophobic material-adsorbent complexes to the regenerative medium.

In some embodiments, the methods of the present disclosure also include a step of reusing the regenerated adsorbent for removing additional hydrophobic materials from a fluid. The methods of the present disclosure can also include a step of purifying the released hydrophobic materials. In some embodiments, the purifying occurs by distillation of the regenerative medium away from the hydrophobic materials.

The methods of the present disclosure may be utilized to remove various hydrophobic materials from various fluids. For instance, in some embodiments, the hydrophobic materials include, without limitation, non-polar molecules, lipophilic molecules, oil, grease, alkanes, hydrocarbons, fats, silicones, fluorocarbons, and combinations thereof. In some embodiments, the fluid includes a water source contaminated with the hydrophobic materials.

### FIGURES

FIG. 1A illustrates a method of removing hydrophobic materials from a fluid.

FIG. 1B depicts a system for removing hydrophobic materials from a fluid.

FIG. 1C depicts a system for regenerating adsorbents for additional removal of hydrophobic materials from a fluid.

FIG. 2A provides a schematic representation of TX₂Sorb, a halloysite-based adsorbent with aluminosilicate- and siloxane-functionalized surfaces. TX₂Sorb has a nanotube-like structure with an open lumen.

FIG. 2B shows an electron micrograph of TX₂Sorb.

FIG. 3 shows a graph of oil removal by two versions of TX₂Sorb (X-23 and X-27) compared to CrudeSorb® (PM-100).

FIG. 4 shows a flow rate as a function of bed volumes for two forms of TX₂Sorb compared to CrudeSorb® (PM-100).

FIG. 5 is a schematic diagram of radial flow canisters containing TX₂Sorb and their deployment to treat produced water.

FIG. 6 is a schematic of a regeneration process for releasing adsorbed oil from TX₂Sorb through solvent treatment (TX₂Gen regeneration process), recovering the oil for secondary markets, and reusing the solvent.

FIG. 7 provides a scheme that compares the utilization of TX₂Sorb and CrudeSorb® in removing hydrophobic materials from produced water.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Hydrophobic materials are a prevalent source of contaminants of various fluids. For instance, the water produced during oil and gas extraction operations (“produced water”) is one of the largest by-products by volume of oil and gas extraction.

Produced water is contaminated with various hydrophobic materials, such as oil and grease. As such, the vast majority of produced water is deep well injected as a disposal method. However, such produced water is not cleaned for secondary uses, such as makeup water in enhanced oil recovery or agriculture.

Furthermore, produced water poses a significant challenge to oil and gas production companies. In particular, the residual oil would have to be extracted before the produced water can be reused or returned to the environment. In fact, U.S. businesses alone incur over $2.5 billion annually in produced water management costs.

Numerous methods and systems are available to remove hydrophobic materials from fluids, such as removal of oil and grease from produced water. Such methods and systems include thermal distillation, membrane systems, and chemical precipitation.

However, the aforementioned methods can have significant drawbacks. For instance, the aforementioned methods are expensive, time consuming, and require experienced operators. Moreover, the aforementioned methods are not environmentally friendly. In addition, the aforementioned methods do not completely remove hydrophobic materials from a fluid.

Filtration has been utilized as an alternative method for removing hydrophobic materials from fluids in order to address the aforementioned drawbacks. However, many filtration methods and adsorbents have limited adsorption capacity, limited adsorbent regeneration capacity, limited adsorbent reusability, and limited recovery of the adsorbed hydrophobic materials.

For instance, sorbent granules sold under the name CrudeSorb® by CETCO offer efficient removal of oil from produced water at reasonable costs. CrudeSorb® is a surface modified smectite clay that has been treated with oleophilic quaternary ammonium compounds. The minerals in CrudeSorb® stack up at the nanoscale with the oleophilic layers between the aluminosilicate layers. The oil in the produced water partitions into this oleophilic layer. As the oil enters this layer, it expands the layer and pushes the clay plates apart. This expansion eventually causes a loss in structural integrity of the sorbent granules and turns them into a pasty mass. Furthermore, any attempt to extract the oil and regenerate CrudeSorb® results in the complete dispersion of both the oil and modified clay into the solvent.

As such, CrudeSorb® cannot be regenerated, thereby making the disposal of spent CrudeSorb® canisters a costly and environmentally challenging proposition. The aforementioned limitations could also provide a liability if the canisters are landfilled incorrectly.

Activated charcoal is also a common granular absorbent utilized to treat wastewater. Activated charcoal, however, has extremely low capacity for removal of oil and grease type organics. For instance, activated charcoal typically can only hold 1 to 2% by weight of oil and grease. As such, activated charcoal's low capacity renders it far too costly to use for removal of oil and grease type organics.

As such, a need exists for improved methods, systems and adsorbents for the removal of hydrophobic materials from various fluids. In particular, a need exists for adsorbents that have optimal hydrophobic material capacity, regeneration capacity, reusability, and the ability to recover the adsorbed hydrophobic materials. Numerous embodiments of the present disclosure address the aforementioned limitations.

In some embodiments, the present disclosure pertains to adsorbents for removing hydrophobic materials from a fluid. In some embodiments, the adsorbents include modified clay and a binding material associated with the modified clay.

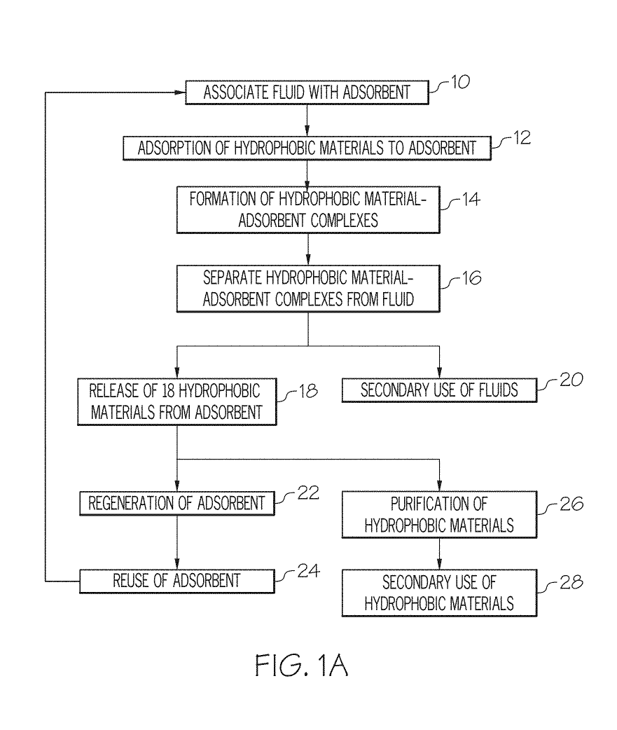

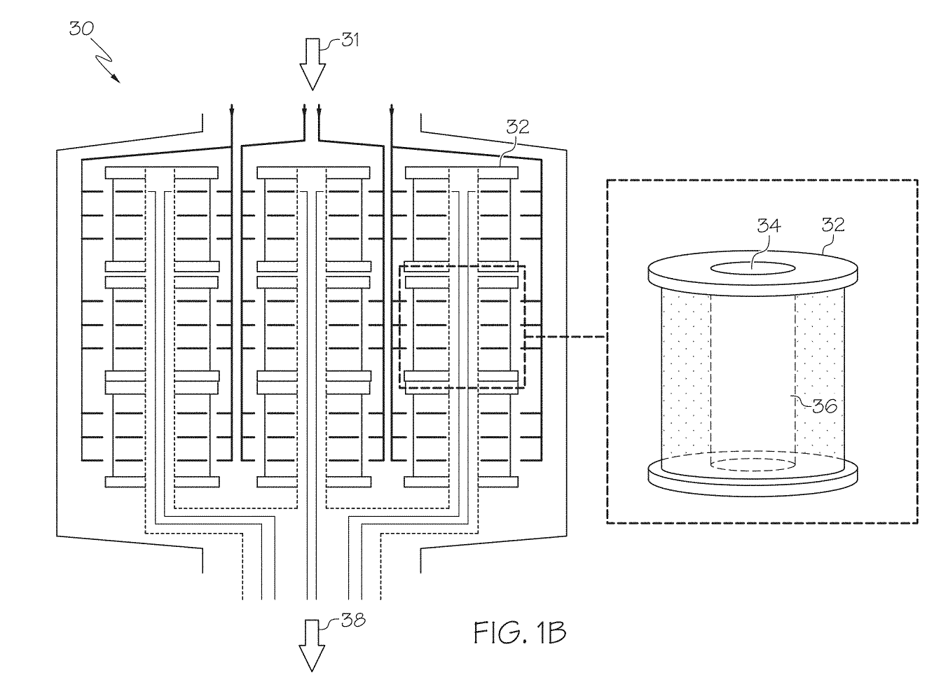

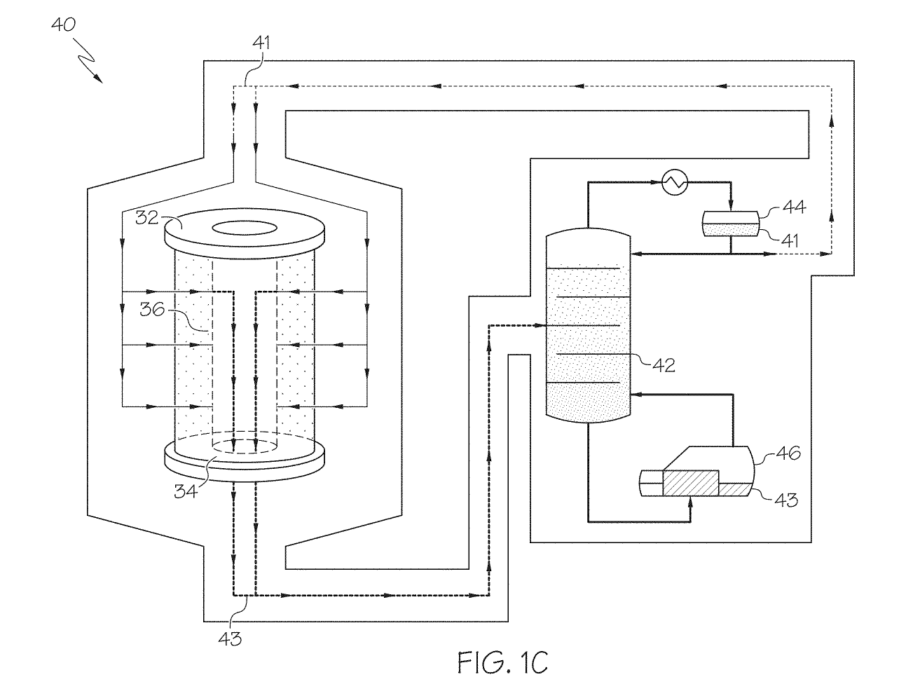

In some embodiments, the present disclosure pertains to methods of removing hydrophobic materials from a fluid by utilizing the adsorbents of the present disclosure. In some embodiments illustrated in FIG. 1A, the methods of the present disclosure include a step of associating the fluid with an adsorbent of the present disclosure (step 10) to result in the adsorption of at least some of the hydrophobic materials from the fluid to the adsorbent (step 12) and the formation of hydrophobic material-adsorbent complexes (step 14).

In some embodiments, the methods of the present disclosure also include a step of separating the hydrophobic material-adsorbent complexes from the fluid (step 16). In some embodiments, the separated fluid may then be utilized for secondary uses (step 20).

In some embodiments, the methods of the present disclosure also include a step of releasing the adsorbed hydrophobic materials from the hydrophobic material-adsorbent complexes (step 18). In some embodiments, the release results in the regeneration of the adsorbent for additional adsorption of hydrophobic materials (step 22). As such, in some embodiments, the methods of the present disclosure also include a step of reusing the regenerated adsorbent for removal of additional hydrophobic materials from a fluid (step 24).

In some embodiments, the methods of the present disclosure also include a step of purifying the released hydrophobic materials (step 26). In some embodiments, the purified hydrophobic materials may be utilized for secondary uses (step 28).

In some embodiments, the present disclosure pertains to systems for removing hydrophobic materials from a fluid by utilizing the adsorbents and methods of the present disclosure. In some embodiments illustrated in FIG. 1B, the systems of the present are represented as system 30. System 30 generally includes a plurality of cartridges 32 that are in fluid communication with hydrophobic material-containing fluid 31. Each cartridge 32 includes lumen 34 and adsorbent 36.

In operation, fluid 31 flows through lumen 34 of cartridge 32 and becomes associated with adsorbent 36 to result in the adsorption of at least some of the hydrophobic materials from the fluid to the adsorbent and the formation of hydrophobic material-adsorbent complexes. Thereafter, fluid 31 is separated from hydrophobic material-adsorbent complexes by flowing the fluid out of system 30 as purified fluid 38. Fluid 38, which contains less hydrophobic materials than fluid 31, can then be utilized for secondary uses or further purified.

In some embodiments, adsorbents 36 can be regenerated by placing containers 32 in a regeneration system, such as regeneration system 40 shown in FIG. 1C. Regeneration system 40 generally includes cartridge 32, container 42, hydrophobic materials container 46, and regenerative media container 44. In operation, the adsorbed hydrophobic materials are released from adsorbent 36 by exposing the adsorbent to a regenerative medium 41. The exposure facilitates the release of hydrophobic materials 43 from adsorbents 36.

Thereafter, the released hydrophobic materials 43 and regenerative medium 41 flow into container 42. The released hydrophobic materials 43 are then purified by distilling the regenerative medium 41 into regenerative medium container 44 for additional use. The retained hydrophobic materials 43 are then placed in hydrophobic materials container 46 for disposal, further purification, or secondary uses.

Thereafter, the regenerated adsorbent 36 can be utilized for removal of additional hydrophobic materials from a fluid. For instance, cartridge 32 containing regenerated adsorbent 36 can be placed back into system 30 (shown in FIG. 1B) for removal of additional hydrophobic materials.

As set forth in more detail herein, the adsorbents, systems and methods of the present disclosure can have numerous embodiments. In particular, the adsorbents of the present disclosure can include various types of modified clay and binding materials. Moreover, various methods and systems may be utilized to remove various types of hydrophobic materials from various fluids. Various methods and systems may also be utilized to release adsorbed hydrophobic materials from hydrophobic material-adsorbent complexes, purify the released hydrophobic materials, and regenerate the adsorbent. In addition, the purified fluids and hydrophobic materials can have numerous secondary uses.

Adsorbents

The adsorbents of the present disclosure generally include modified clay and a binding material associated with the modified clay. As set forth in more detail herein, the adsorbents of the present disclosure may include various types of modified clay and binding materials. Moreover, the binding materials and modified clay may be associated with one another in various manners.

Modified clays generally refer to clays that have been modified with one or more functional groups. In some embodiments, the modified clays may include surface modified clays. In some embodiments, the modified clay may include, without limitation, smectite, halloysite, palygorskite, kaolinite, montmorillonite-smectite, illite, chlorite, montmorillonite, hectorite, attapulgite, and combinations thereof. In some embodiments, the modified clay includes halloysite.

The modified clays of the present disclosure may be functionalized with various functional groups. For instance, in some embodiments, the modified clay is functionalized with a plurality of oleophilic functional groups.

Oleophilic functional groups generally include functional groups that have an affinity for hydrophobic materials, such as oil. In some embodiments, the oleophilic functional groups associated with modified clays include, without limitation, silane coupling agents, silanes, alkyl functionalized silanes, silica, siloxanes, aluminol, aluminosilicates, alkyl groups, organocations, and combinations thereof.

In some embodiments, the oleophilic functional groups include silane coupling agents. In some embodiments, the oleophilic functional groups include alkyl functionalized silanes. In some embodiments, the alkyl groups of the alkyl functionalized silanes include, without limitation, octyl groups, dodecyl groups, octyldecyl groups, benzyl groups, and combinations thereof.

In some embodiments, the oleophilic functional groups include organocations. In some embodiments, the organocations include, without limitation, quaternary ammonium salts, phosphonium salts, and combinations thereof. In some embodiments, the organocations include quaternary ammonium salts, such as quaternary alkylammonium ions. In some embodiments, the organocations include phosphonium salts, such as alkyl phosphonium salts.

Functional groups may be positioned on various regions of modified clays. For instance, in some embodiments, the functional groups may be positioned on a surface of the modified clays. In some embodiments, the functional groups may be positioned on edges of the modified clay. In some embodiments, the functional groups may be within internal cavities or pores of the modified clays. In some embodiments, the functional groups may be positioned between layers of the modified clays.

The modified clays of the present disclosure may be prepared by various processes. For instance, in some embodiments, the modified clays of the present disclosure may be prepared through treatment of a clay with a quaternary ammonium salt. In some embodiments, the modified clays of the present disclosure may be prepared through treatment of a clay with a silane coupling agent.

In some embodiments, the modified clays of the present disclosure may include smectite treated with a quaternary ammonium salt. In some embodiments, the modified clays of the present disclosure may include halloysite treated with a silane coupling agent or a quaternary ammonium ion. In some embodiments, the modified clays of the present disclosure may include palygorskite treated with a silane coupling agent or a quaternary ammonium ion.

The adsorbents of the present disclosure may also include various types of binding materials. Binding materials generally refer to materials that enhance the structural integrity of the adsorbents of the present disclosure. In some embodiments, the binding materials allow the adsorbents of the present disclosure to be regenerated and reused multiple times.

In some embodiments, the binding materials of the present disclosure are hydrophobic. In some embodiments, the binding materials of the present disclosure include, without limitation, polymers, asphalt, cement, and combinations thereof. In some embodiments, the binding material includes a polymer, such as a thermoplastic polymer, a thermoset polymer, and combinations thereof.

In some embodiments, the binding materials of the present disclosure include thermoplastic polymers. In some embodiments, the thermoplastic polymers include, without limitation, poly(methyl methacrylate), acrylonitrile butadiene styrene, nylon, polylactic acid, polybenzimidazole, polycarbonate, polyether sulfone, polyoxymethylene, polyetherether ketone, polyetherimide, polyethylene, polyphenylene oxide, polyphenylene sulfide, polypropylene, polystyrene, polyvinyl chloride, Teflon, and combinations thereof. In some embodiments, the thermoplastic polymer includes polypropylene. In some embodiments, the thermoplastic polymers include polyethylene.

In some embodiments, the binding materials of the present disclosure include thermoset polymers. In some embodiments, the thermoset polymers include, without limitation, polyester resins, polyurethanes, polyureas, vulcanized rubber, melamine resins, epoxy resins, benzoxazines, polyimides, bismaleimides, cyanate esters, furan resins, silicone resins, vinyl ester resins, and combinations thereof. In some embodiments, the thermoset polymers include a thermoset resin, such as an epoxy resin or polyurethane.

The modified clay and binding materials of the present disclosure may be associated with one another in various manners. For instance, in some embodiments, the binding material and the modified clay are intertwined with one another. In some embodiments, the binding material forms a layer or coating on a surface of the modified clay. In some embodiments, the binding material forms a hydrophobic layer or coating on a surface of the modified clay.

In some embodiments, modified clay and binding materials are associated with one another such that they form a composite. In some embodiments, the modified clay and binding materials are homogenously distributed within the composite. In some embodiments, the composite is in the form of a tactoid composite (e.g., a tactoidal nanocomposite between a surface modified clay and a polymer). In some embodiments, the composite is in the form of an intercalation composite, where binding materials are intercalated between modified clay layers (e.g., a nanocomposite structure where polymers are intercalated between surface modified clay layers). In some embodiments, the composite structure is in the form of exfoliation composites, where binding materials are between exfoliated modified clay layers (e.g., nanocomposite structures where a surface modified clay is exfoliated into polymers). Additional forms of association can also be envisioned.

The adsorbents of the present disclosure may have various shapes. For instance, in some embodiments, the adsorbents are in the form of at least one of particles, nanoparticles, composites, micro-composites, macro-composites, granules, nanotubes, cylinders, and combinations thereof. In some embodiments, the adsorbents of the present disclosure are in granular form. In some embodiments, the adsorbents of the present disclosure are in the form of nanotubes.

In some embodiments, the adsorbents of the present disclosure are in the form of cylinders that have an open lumen running through the length of the cylinder. In some embodiments, the open lumen is functionalized with a plurality of functional groups. In some embodiments, the open lumen has a diameter ranging from about 10 nm to about 100 μm. In some embodiments, the open lumen has a diameter ranging from about 10 nm to about 500 nm. In some embodiments, the open lumen has a diameter ranging from about 30 nm to about 100 nm.

The adsorbents of the present disclosure may be placed in various containers for removal of hydrophobic materials. For instance, in some embodiments, the adsorbents of the present disclosure are placed in a cartridge. In more specific embodiments, the adsorbents of the present disclosure are placed in a radial flow canister that serves as a drop-in replacement for existing adsorbents (e.g., canisters in the form of container 32 shown in FIG. 1B). In some embodiments, the cartridge serves as a drop-in replacement for existing adsorbents within existing systems.

The adsorbents of the present disclosure may include various adsorption capacities for hydrophobic materials. For instance, in some embodiments, the adsorbents of the present disclosure may include hydrophobic material adsorption capacities of more than about 80 wt %. In some embodiments, the adsorbents of the present disclosure may include hydrophobic material adsorption capacities of at least about 100 wt %. In some embodiments, the adsorbents of the present disclosure may include hydrophobic material adsorption capacities of more than about 100 wt %.

In some embodiments, the hydrophobic material adsorption capacities of the adsorbents of the present disclosure do not change significantly after regeneration. For instance, in some embodiments, the hydrophobic material adsorption capacities are reduced by no more than 1% after each regeneration cycle. In some embodiments, the hydrophobic material adsorption capacities are reduced by no more than 5% after each regeneration cycle. In some embodiments, the hydrophobic material adsorption capacities are reduced by no more than 10% after each regeneration cycle.

Association of Fluids with Adsorbents

Various methods may be utilized to associate fluids with the adsorbents of the present disclosure. For instance, in some embodiments, the association occurs by contacting the fluid with the adsorbent. In some embodiments, the association occurs by mixing the fluid with the adsorbent. In some embodiments, the association occurs by flowing the fluid through the adsorbent. In some embodiments, the flowing occurs through radial flow.

In some embodiments, the adsorbent is placed in a container during the flowing. Suitable containers were described previously. For instance, in some embodiments, the adsorbent is placed in a radial flow canister during the flowing.

In some embodiments, the flowing occurs at flow rates that do not change substantially with time. For instance, in some embodiments, the flow rates do not drop more than 5% of the original flow rate after 11 L of fluid flow through the adsorbent. In some embodiments, the flow rates do not drop more than 10% of the original flow rate after 11 L of fluid flow through the adsorbent. In some embodiments, the flow rates do not drop more than 20% of the original flow rate after 11 L of fluid flow through the adsorbent.

Fluids

The adsorbents of the present disclosure may be utilized to remove hydrophobic materials from various fluids. For instance, in some embodiments, the fluids include, without limitation, hydrophilic fluids, polar fluids, water, and combinations thereof. In some embodiments, the fluids include a water source contaminated with hydrophobic materials. In some embodiments, the fluids include industrial waste water. In some embodiments, the fluids include water produced during oil and gas extraction operations (i.e., produced water).

Hydrophobic Materials

The fluids of the present disclosure may include various hydrophobic materials for removal by adsorbents. For instance, in some embodiments, the hydrophobic materials include, without limitation, non-polar molecules, lipophilic molecules, oil, grease, alkanes, hydrocarbons, fats, silicones, fluorocarbons, and combinations thereof. In some embodiments, the hydrophobic materials include oil.

Formation of Hydrophobic Material-Adsorbent Complexes

The association of fluids with the adsorbents of the present disclosure generally results in adsorption of at least some of the hydrophobic materials in the fluid to the adsorbent and the formation of hydrophobic material-adsorbent complexes. Without being bound by theory, such adsorption can occur through various interactions. For instance, in some embodiments, the adsorption occurs through non-covalent interactions between the hydrophobic materials and the adsorbent. In some embodiments, the non-covalent interactions include, without limitation, ionic interactions, physisorption, chemisorption, hydrogen bonding, van der Waals interactions, and combinations thereof.

Separation of Hydrophobic Material-Adsorbent Complexes from Fluids

In some embodiments, the methods of the present disclosure also include a step of separating the hydrophobic material-adsorbent complexes from a fluid. Various separation methods may be utilized.

For instance, in some embodiments, the separation occurs by flowing the fluids away from immobilized hydrophobic material-adsorbent complexes (e.g., the flowing of fluid 31 away from adsorbents 36, as shown in FIG. 1B). In some embodiments, the separation occurs by decanting. In some embodiments, the separation occurs by centrifugation. Additional separation methods can also be envisioned.

In some embodiments, the fluid separated from hydrophobic material-adsorbent complexes may have less hydrophobic materials than the untreated fluid. As such, the separated fluid may be utilized for secondary uses. For instance, in some embodiments where the fluid is water, the fluid may be utilized in agriculture, such as watering livestock or growing crops. In some embodiments, the fluid may be utilized in enhanced oil recovery. Additional secondary uses can also be envisioned.

Release of Adsorbed Hydrophobic Materials

In some embodiments, the methods of the present disclosure also include a step of releasing the adsorbed hydrophobic materials from the hydrophobic material-adsorbent complexes. Release of adsorbed hydrophobic materials from hydrophobic material-adsorbent complexes can occur through various methods. For instance, in some embodiments, the release occurs by exposing the hydrophobic material-adsorbent complexes to a regenerative medium. In some embodiments, the exposure results in a transfer of hydrophobic materials from the hydrophobic material-adsorbent complexes to the regenerative medium.

Various regenerative media may be utilized to release hydrophobic materials from hydrophobic material-adsorbent complexes. For instance, in some embodiments, the regenerative medium is a solvent, such as an environmentally friendly solvent. In some embodiments, the solvent includes a polar solvent. In some embodiments, the solvent includes an alcohol-based solvent. In some embodiments, the alcohol-based solvent includes, without limitation, methanol, ethanol, propanol, and combinations thereof. In some embodiments, the solvent includes ethyl lactate.

Purification of Hydrophobic Materials

In some embodiments, the methods of the present disclosure also include a step of purifying the released hydrophobic materials. Various methods may also be utilized to purify hydrophobic materials. For instance, in some embodiments, the purifying occurs by distillation of the regenerative medium away from the hydrophobic material. In some embodiments, the purifying occurs by evaporating the regenerative medium away from the hydrophobic material. In some embodiments, the purifying occurs by gravity separation of the regenerative medium from the hydrophobic material.

In some embodiments, the separated regenerative medium after a purification step may be recycled. For instance, in some embodiments, the regenerative medium may be utilized for additional release of adsorbed hydrophobic materials (e.g., recycling of regenerative medium 41, as shown in FIG. 1C).

In some embodiments, the purified hydrophobic materials may be utilized for secondary uses. For instance, in some embodiments where the purified hydrophobic material is oil, the purified oil may be sold in crude form or further refined.

Regeneration and Reuse of Adsorbents

In some embodiments, the release of hydrophobic materials from the adsorbent results in the regeneration of the adsorbents. The regenerated adsorbents may then be utilized for additional removal of hydrophobic materials from fluids. As such, in some embodiments, the methods of the present disclosure may also include a step of reusing the regenerated adsorbent for removal of hydrophobic materials from a fluid.

The adsorbents of the present disclosure may be reused multiple times after each cycle of regeneration. For instance, in some embodiments, the adsorbents of the present disclosure may be reused from about 2 times to about 20 times. In some embodiments, the adsorbents of the present disclosure may be reused from about 3 times to about 10 times. In some embodiments, the adsorbents of the present disclosure may be reused more than twice. In some embodiments, the adsorbents of the present disclosure may be reused more than three times. In some embodiments, the adsorbents of the present disclosure may be reused more than five times.

### Applications and Advantages

The methods, systems, and adsorbents of the present disclosure provide numerous advantages, including high adsorption capacity for hydrophobic materials, ability of the adsorbents to be regenerated and reused multiple times, and the ability to recover the adsorbed hydrophobic materials for secondary uses. Moreover, the methods, systems and adsorbents of the present disclosure can provide a closed loop system that generates no waste, including hazardous waste.

Furthermore, the methods, systems and adsorbents of the present disclosure are cost effective. For instance, the methods, systems and adsorbents of the present disclosure can seamlessly merge with existing infrastructures of various purification systems with minimal adoption or training costs.

Moreover, the methods, systems and adsorbents of the present disclosure are environmentally friendly. For instance, in some embodiments, the methods, systems and adsorbents of the present disclosure can be utilized to adsorb, release, and purify hydrophobic materials for secondary uses. As such, the methods and adsorbents of the present disclosure mitigate the use of landfill-based disposal of the hydrophobic materials.

Therefore, the methods, systems and adsorbents of the present disclosure can find numerous applications. For instance, in some embodiments, the methods, systems and adsorbents of the present disclosure can find on-shore or off-shore applications for produced water treatment and management. In some embodiments, the methods, systems and adsorbents of the present disclosure can be utilized for produced water treatment derived from hydraulic fracturing, enhanced oil recovery, and deep well injection. In additional embodiments, the methods, systems and adsorbents of the present disclosure can be utilized for treating additional water sources where a buildup of oil causes the premature dumping of wastewater, such as metal phosphating or commercial car and equipment washing operations.

The fluids purified by the methods, systems and adsorbents of the present disclosure can also find numerous applications. For instance, in some embodiments, purified water can be utilized for secondary uses, such as watering livestock, growing crops, or utilization in enhanced oil recovery.

### Additional Embodiments

Reference will now be made to more specific embodiments of the present disclosure and experimental results that provide support for such embodiments. However, Applicants note that the disclosure herein is for illustrative purposes only and is not intended to limit the scope of the claimed subject matter in any way.

### Example 1. Characterization and Use of TX₂Sorb

In this Example, Applicants summarize the characterization of TX₂Sorb, a new adsorbent that exhibits the characteristics of CrudeSorb® for removal of oil without the downside of disposal. TX₂Sorb is substantially more eco-friendly in that it is fully rechargeable and can be reused at least 3-10 times with little to no degradation. This significantly reduces the need for landfill disposal and the potential long term liability associated with disposal.

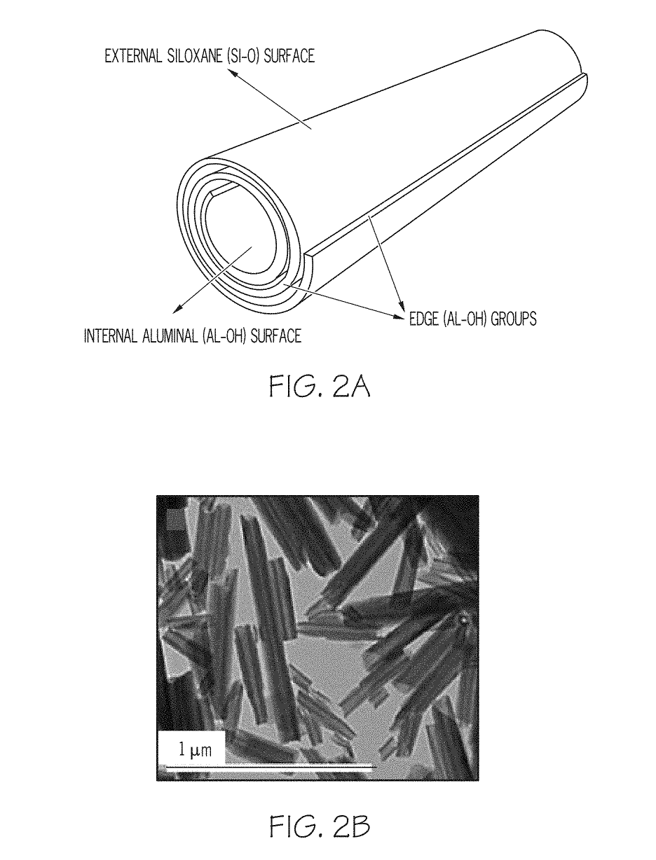

In this Example, TX₂Sorb is housed in a radial flow canister, which can be a drop-in replacement for the existing infrastructures, including the CrudeSorb® infrastructure. As illustrated in FIG. 2A, TX₂Sorb contains a surface modified aluminosilicate nanotube. The nanotubes are a naturally occurring clay named halloysite. Halloysite can be pictured in FIG. 2A as a rolled up scroll that has an open lumen running the length of the cylinder. FIG. 2B contains an electron micrograph of the actual mineral.

As can be seen in FIG. 2B, the halloysite in TX₂Sorb is typically micron in length and approximately 100 nm in diameter. The open lumen is in the range of 30 to 50 nm in diameter. The lumen is covered with OH groups that can react with silane coupling agents with oleophilic R groups. This renders the inside of the lumen oleophilic as is the case with CrudeSorb®.

As the oil partitions into the lumen of TX₂Sorb, the clay will maintain its structural integrity and not turn into amorphous structures. After the lumen is filled with oil, the oil can be extracted and the TX₂Sorb regenerated by a mild solvent extraction.

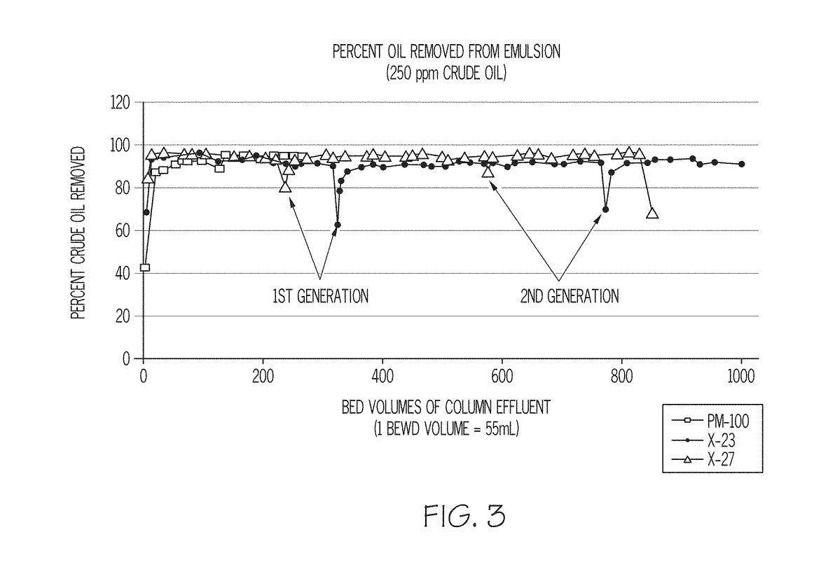

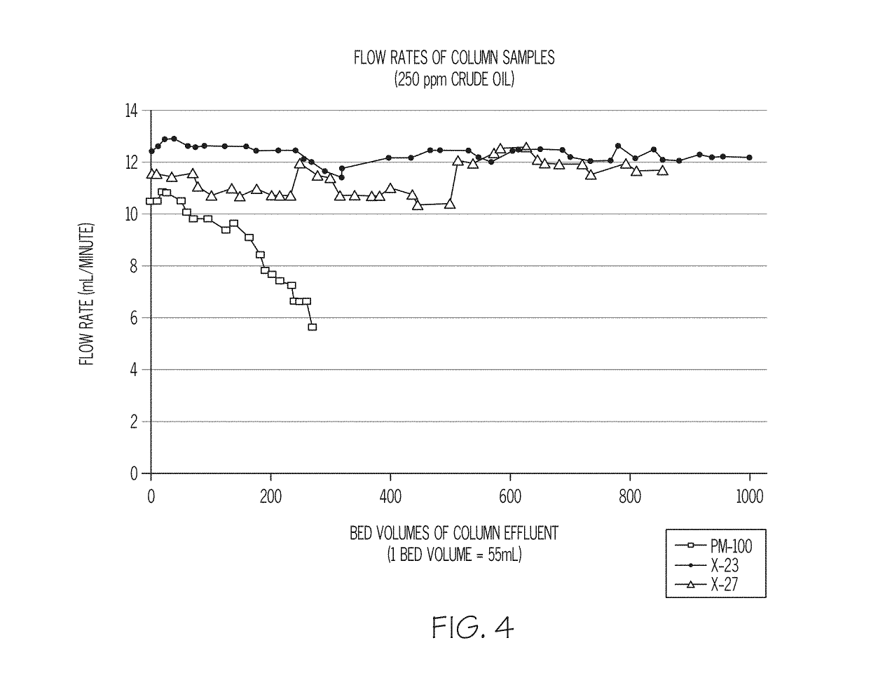

To demonstrate TX₂Sorb's efficacy, small laboratory columns of 1 inch diameter and approximately 6 inches high were used to treat a simulated produced water. FIG. 3 shows the results of those tests. It can be seen that the removal efficiency is equal to CrudeSorb® and that as the removal efficiency starts to go down the two forms of TX₂Sorb can be regenerated with a solvent wash utilizing ethanol as a solvent and returned to its original efficacy. The detrimental effects of swelling on flowrate for CrudeSorb® can be seen in FIG. 4 where the flowrate starts to drop off quickly for CrudeSorb® (PM-100) but is essentially unchanged for the two types of TX₂Sorb (X-23 and X-27).

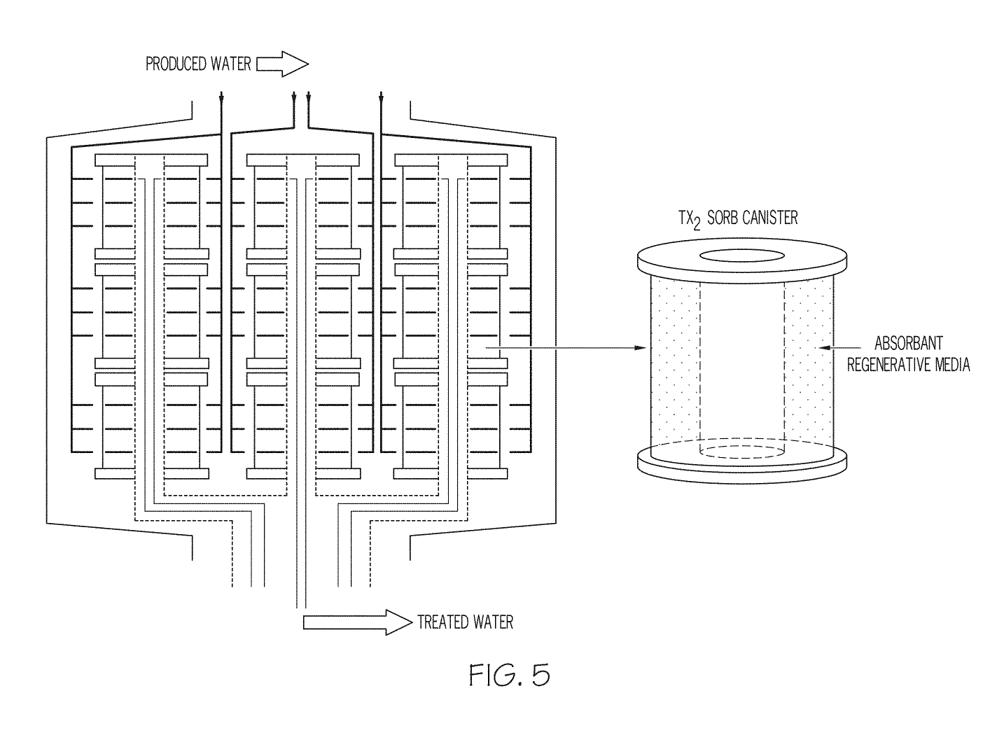

As illustrated in FIG. 5, TX₂Sorb can be housed in radial flow canisters to facilitate the loading and unloading of pressure vessels utilized in the field to treat produced water. This allows the replacement of existing CrudeSorb® canisters with TX₂Sorb with zero adoption cost for the end user since the TX₂Sorb canisters are exactly the same dimensions as CrudeSorb®.

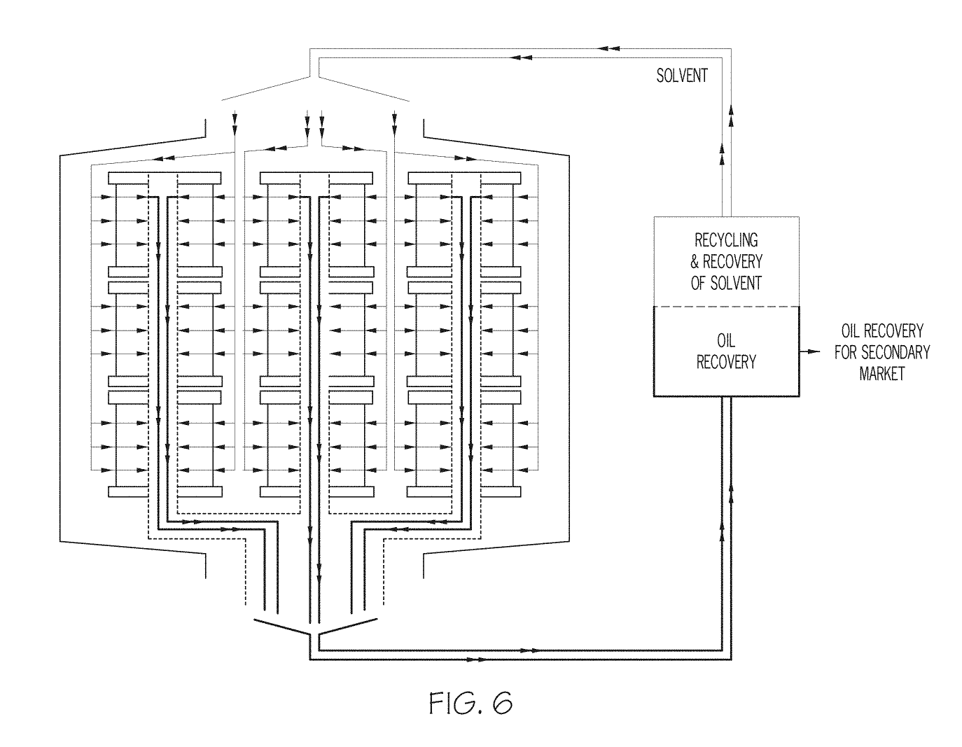

After the TX₂Sorb canisters are full of oil, they can be removed and transported to a centralized regeneration facility. FIG. 6 provides a schematic of this operation, which is also referred to as TX₂Gen. In the process, an ecofriendly solvent is utilized to extract the oil from TX₂Sorb followed by a distillation step where the oil is recovered and solvent recycled. The preferred solvents are ethanol and ethyl lactate, which are both from renewable resources.

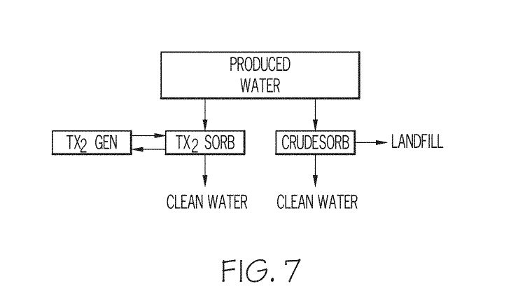

As illustrated in FIG. 7, the combination of TX₂Sorb and TX₂Gen applied to treatment of produced water will result in zero waste generation. However, such results cannot be achieved by CrudeSorb®.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of removing hydrophobic materials from a fluid, said method comprising:
associating the fluid with an adsorbent,
wherein the adsorbent comprises modified clay and a binding material associated with the modified clay, and
wherein the associating results in adsorption of at least some of the hydrophobic materials from the fluid to the adsorbent to form hydrophobic material-adsorbent complexes.

2. The method of claim 1, further comprising a step of separating the hydrophobic material-adsorbent complexes from the fluid.

3. The method of claim 1, further comprising a step of releasing the adsorbed hydrophobic materials from the hydrophobic material-adsorbent complexes to result in the regeneration of the adsorbent.

4. The method of claim 3, wherein the releasing comprises exposing the hydrophobic material-adsorbent complexes to a regenerative medium, wherein the exposing results in a transfer of the hydrophobic materials from the hydrophobic material-adsorbent complexes to the regenerative medium.

5. The method of claim 4, wherein the regenerative medium is a solvent.

6. The method of claim 4, further comprising a step of purifying the released hydrophobic materials.

7. The method of claim 6, wherein the purifying comprises distillation of the regenerative medium away from the hydrophobic materials.

8. The method of claim 3, further comprising a step of reusing the regenerated adsorbent for removing hydrophobic materials from a fluid.

9. The method of claim 1, wherein the hydrophobic materials are selected from the group consisting of non-polar molecules, lipophilic molecules, oil, grease, alkanes, hydrocarbons, fats, silicones, fluorocarbons, and combinations thereof.

10. The method of claim 1, wherein the hydrophobic materials comprise oil.

11. The method of claim 1, wherein the fluid comprises a water source contaminated with the hydrophobic materials.

12. The method of claim 1, wherein the associating comprises flowing the fluid through the adsorbent.

13. The method of claim 1, wherein the modified clay is selected from the group consisting of smectite, halloysite, palygorskite, kaolinite, montmorillonite-smectite, illite, chlorite, montmorillonite, hectorite, attapulgite, and combinations thereof.

14. The method of claim 1, wherein the modified clay is functionalized with a plurality of oleophilic functional groups.

15. The method of claim 14, wherein the oleophilic functional groups are selected from the group consisting of silane coupling agents, silanes, alkyl functionalized silanes, silica, siloxanes, aluminol, aluminosilicates, alkyl groups, organocations, and combinations thereof.

16. The method of claim 1, wherein the binding material is selected from the group consisting of polymers, asphalt, cement, and combinations thereof.

17. The method of claim 1, wherein the binding material is hydrophobic.

18. The method of claim 1, wherein the binding material comprises a polymer.

19. The method of claim 18, wherein the polymer comprises a thermoplastic polymer or a thermoset polymer.

20. The method of claim 18, wherein the polymer comprises a thermoplastic polymer selected from the group consisting of poly(methyl methacrylate), acrylonitrile butadiene styrene, nylon, polylactic acid, polybenzimidazole, polycarbonate, polyether sulfone, polyoxymethylene, polyetherether ketone, polyetherimide, polyethylene, polyphenylene oxide, polyphenylene sulfide, polypropylene, polystyrene, polyvinyl chloride, Teflon, and combinations thereof.

21. The method of claim 18, wherein the polymer comprises a thermoset polymer selected from the group consisting of polyester resins, polyurethanes, polyureas, vulcanized rubber, melamine resins, epoxy resins, benzoxazines, polyimides, bismaleimides, cyanate esters, furan resins, silicone resins, vinyl ester resins, and combinations thereof.

22. An adsorbent for removing hydrophobic materials from a fluid,
wherein the adsorbent comprises modified clay and a binding material associated with the modified clay.

23. The adsorbent of claim 22, wherein the modified clay is selected from the group consisting of smectite, halloysite, palygorskite, kaolinite, montmorillonite-smectite, illite, chlorite, montmorillonite, hectorite, attapulgite, and combinations thereof.

24. The adsorbent of claim 22, wherein the modified clay is functionalized with a plurality of oleophilic functional groups.

25. The adsorbent of claim 24, wherein the oleophilic functional groups are selected from the group consisting of silane coupling agents, silanes, alkyl functionalized silanes, silica, siloxanes, aluminol, aluminosilicates, alkyl groups, organocations, and combinations thereof.

26. The adsorbent of claim 22, wherein the binding material is selected from the group consisting of polymers, asphalt, cement, and combinations thereof.

27. The adsorbent of claim 22, wherein the binding material is hydrophobic.

28. The adsorbent of claim 22, wherein the binding material comprises a polymer.

29. The adsorbent of claim 28, wherein the polymer comprises a thermoplastic polymer or a thermoset polymer.

30. The adsorbent of claim 28, wherein the polymer comprises a thermoplastic polymer selected from the group consisting of poly(methyl methacrylate), acrylonitrile butadiene styrene, nylon, polylactic acid, polybenzimidazole, polycarbonate, polyether sulfone, polyoxymethylene, polyetherether ketone, polyetherimide, polyethylene, polyphenylene oxide, polyphenylene sulfide, polypropylene, polystyrene, polyvinyl chloride, Teflon, and combinations thereof.

31. The adsorbent of claim 28, wherein the polymer comprises a thermoset polymer selected from the group consisting of polyester resins, polyurethanes, polyureas, vulcanized rubber, melamine resins, epoxy resins, benzoxazines, polyimides, bismaleimides, cyanate esters, furan resins, silicone resins, vinyl ester resins, and combinations thereof.
